(19) United States
(12) Patent Application Publication
(10) Pub. No.: US 2025/0324257 A1
(43) Pub. Date: Oct. 16, 2025

(54) MOBILE DEVICE SECURITY PROFILING

(71) Applicant: Verizon Patent and Licensing Inc., Basking Ridge, NJ (US)

(72) Inventors: Timothy E Coyle, Chicopee, MA (US); Vinod K Choyi, Conshohocken, PA (US); Ammara Essa, Los Angeles, CA (US); Hector A Garcia Crespo, North Richland Hills, TX (US)

(21) Appl. No.: 18/632,369

(22) Filed: Apr. 11, 2024

(51) Int. Cl. H04W 12/122; H04W 12/30

(52) U.S. Cl. CPC H04W 12/122; H04W 12/30

(57) ABSTRACT

One or more computing devices, systems, and/or methods for mobile device security profiling are provided. A device connected to a communication network is detected. Device profile information associated with the device is used to select a device behavior security model from available device behavior security models. The device behavior security model is provided to the device. The device utilizes the device behavior security model to determine whether the device is exhibiting normal operating behavior or abnormal operating behavior (e.g., an application on the device performing a denial of service attack). If abnormal operating behavior is detected by the device, then the device can perform a remedial action.

### BACKGROUND

A communication network, such as a wireless cellular network, supports a variety of different types of devices such as mobile phones, tablets, smart devices, and/or other user equipment (UE). A device connected to the network may start to exhibit abnormal behavior such as where a newly installed app starts to perform malicious activity (e.g., perform a denial-of-service (DoS) attack, or any other security attack) or where there is an exploited vulnerability in a previously installed app. Once the communication network identifies the abnormal behavior, the communication network can attempt to perform reactive measures such as by forcing the device to reattach to the communication network and clear out session data.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for mobile device security profiling, in accordance with an embodiment of the present technology;

FIG. 2 is a flow chart illustrating an example method for mobile device security profiling, in accordance with an embodiment of the present technology;

FIG. 3A illustrates an example of a system for mobile device security profiling that includes a training phase, in accordance with an embodiment of the present technology;

FIG. 3B illustrates an example of a system for mobile device security profiling that includes a device activation phase, in accordance with an embodiment of the present technology;

FIG. 4 illustrates an example of a system for mobile device security profiling that includes an ongoing profiling phase, in accordance with an embodiment of the present technology;

FIG. 5 is a flow chart illustrating an example method for mobile device security profiling, in accordance with an embodiment of the present technology;

FIG. 6 is an illustration of example networks that may utilize and/or

implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine-readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

Systems and methods are provided for mobile device security profiling. Various types of devices such as mobile phones, smart watches, tablets, and other UEs may connect to a communication network in order to communicate over the communication network and access services. The communication network may implement various types of security functionality to detect abnormal behavior of devices (e.g., malicious behavior of an application such as flooding the communication network with attachment requests) in order to reactively protect the communication network from the abnormal behavior such as network attacks, denial of service attacks, and/or other malicious behavior. These measures are reactive, and the communication network may not be able to quickly identify and react to such abnormal behavior because the devices themselves are not self-aware and are unable to determine whether their own behavior is normal or abnormal.

The disclosed techniques improve security of the communication network through mobile device security profiling. The mobile device security profiling enables devices to determine whether their behavior is normal or abnormal so that the devices can quickly perform remedial actions to protect the communication network from security issues and attacks otherwise resulting from abnormal behavior. The mobile device security profiling is implemented as a multi-stage approach that includes a training phase for creating device behavior security models (e.g., creating initial/baseline models), a device activation phase where devices retrieve and load appropriate device behavior security models, and an ongoing profiling phase where devices monitor for abnormal behavior in order to perform remedial actions. During the ongoing profiling phase, the device behavior security models are updated or are newly created based up feedback from devices, and the devices retrieve and utilize the latest device behavior security models. In this way, a device can directly self-identify abnormal behavior and quickly perform a remedial action to protect the communication network.

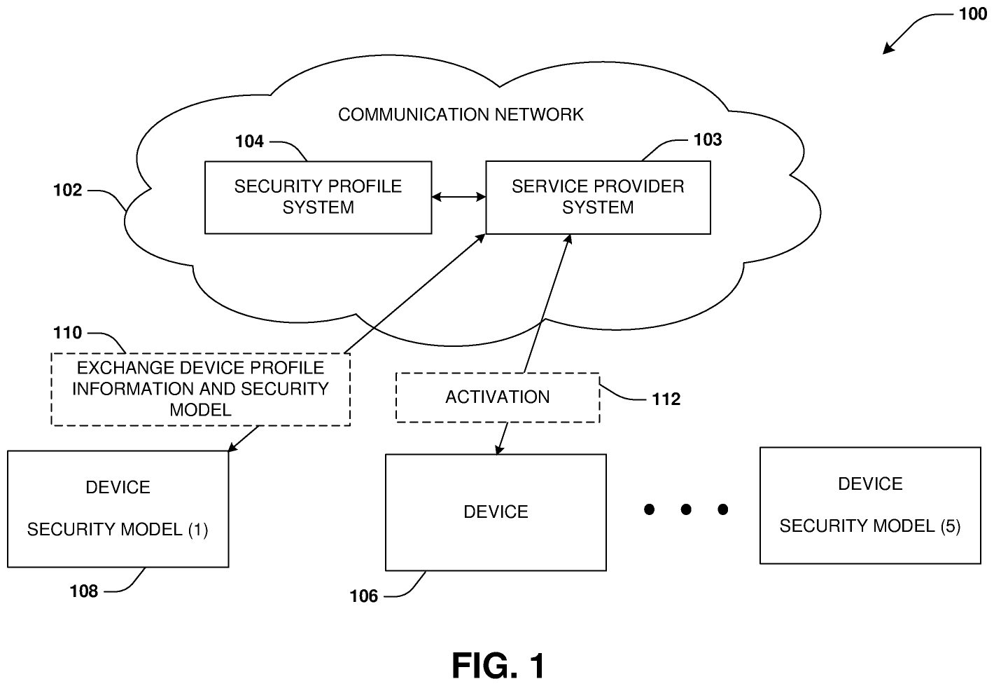

FIG. 1 illustrates an example of a system 100 for mobile device security profiling. A communication network 102, such as a cellular network, provides devices with voice services, data services, and/or other services (e.g., a smart device may be capable of making phone calls, texting, accessing voicemail, web browsing, accessing services, and/or performing other functionality over the communication network 102). In some embodiments, a device 106 may establish a connection to the communication network 102 in order to activate 112 with a service provider system 103 so that the device 106 can connect to and communicate over the communication network 102.

As provided herein, a security profile system 104 is configured to create and provide device behavior security models to devices. In some embodiments, the device behavior security models are provided to devices already connected to the communication network. In some embodiments, the device behavior security models are provided to devices such as during the activation 112 of the device 106. As part of creating the device behavior security models, the security profile system 104 simulates device operation within the communication network, such as normal behavior and abnormal behavior. The simulations are used to train device behavior security models that can be used by devices to detect whether the devices are exhibiting normal behavior or abnormal behavior. The service provider system 103 may obtain device profile information from the device 106, such as part of the activation 112. The device profile information may include a device type (e.g., a particular model of a smart watch), an operating system version, a firmware version, a description of an installed application, locational information (e.g., a geographical location of the device), user information, etc. The device profile information is used to identify a device behavior security model that best matches the device profile information such that the device behavior security model will provide accurate indications of whether certain behavior of this particular device is normal behavior or abnormal behavior. In this way, the device behavior security model is loaded into the device 106, such as during activation 112.

A device 108 may have been previously loaded with a device behavior security model. The device 108 may periodically compare device operating activity (e.g., information within system logs such as application activity, how the device 108 reacts to network connects, activity/data streams, messages exchanged between the device 108 and the communication network 102, and/or other device signals) with the device behavior security model to determine whether the device 108 is exhibiting abnormal/anomalous behavior or normal behavior. If an abnormal behavior is detected, then the device 108 performs a remedial action such as shutting down a radio of the device, disconnecting from the communication network 102, closing an application, displaying a warning, sending a warning email or text message to a user or the service provider, generating a report for the service provider, restarting the device 108, blocking access to application(s) likely to be causing the abnormal behavior, blacklisting applications, blocking an application from executing, etc.

In some embodiments, the device 108 may exchange 110 information with the security profile system 104. In some embodiments, the device 108 may exchange 110 the information through the service provider system 103 to the security profile system 104. The device 108 may send updated device profile information to the security profile system 104. The security profile system 104 may utilize the updated device profile information (e.g., describing new or deleted applications, a current operating system version, a current firmware version, recent locational information, recent user behavior, etc.) to determine whether the current device behavior security model being used by the device 108 is the model that will provide the most accurate indications of whether behavior of the device 108 is indicative of normal or abnormal behavior. If the current device behavior security model is not the most accurate, then the security profile system 104 identifies the device behavior security model that is the most accurate, and provides the device behavior security model to the device 108 to use in place of the current device behavior security model.

The security profile system 104 may also utilize feedback provided by the device 108 (e.g., the updated device profile information may include information within system logs such as application activity, how the device 108 reacts to network connects, activity/data streams, messages exchanged between the device 108 and the communication network 102, and/or other device signals that were classified as abnormal behavior or normal behavior) to update and/or create new device behavior security models to provide to the device 108 and/or other devices.

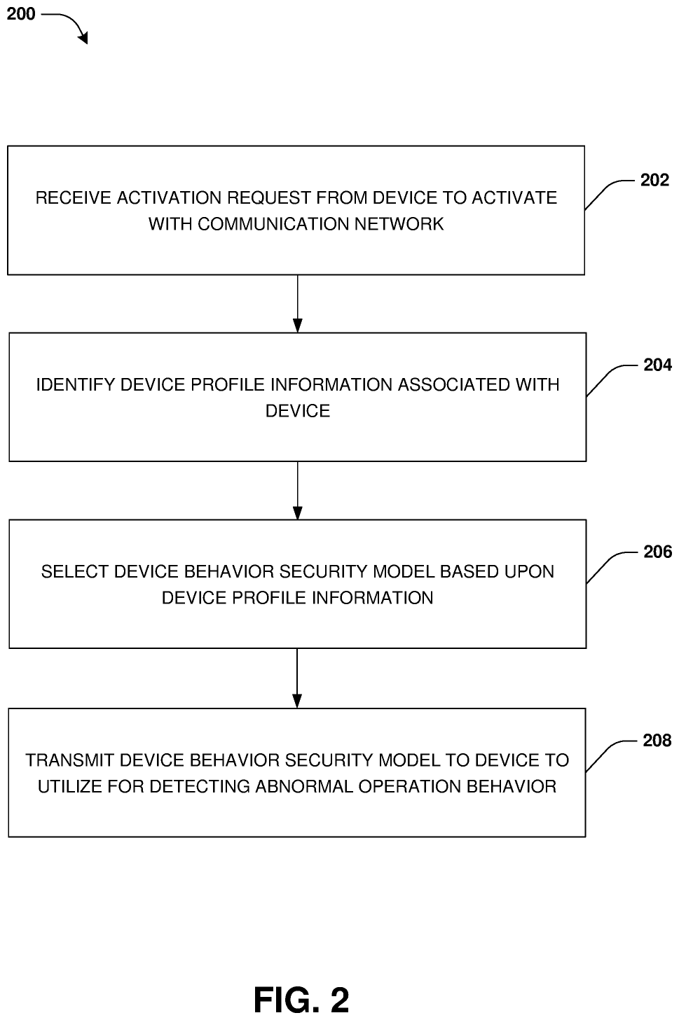

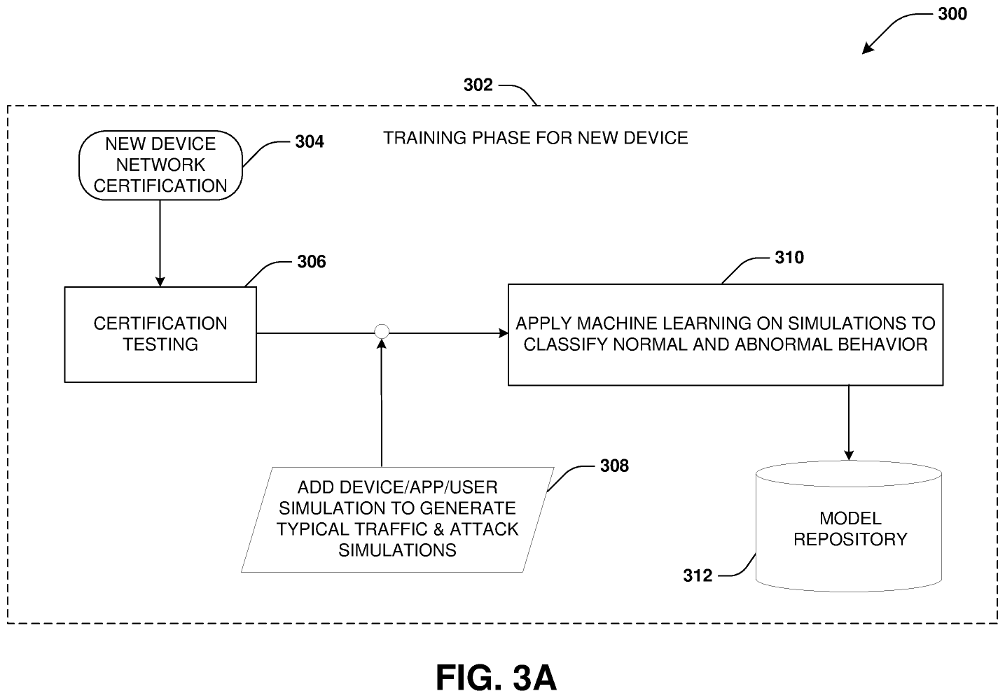

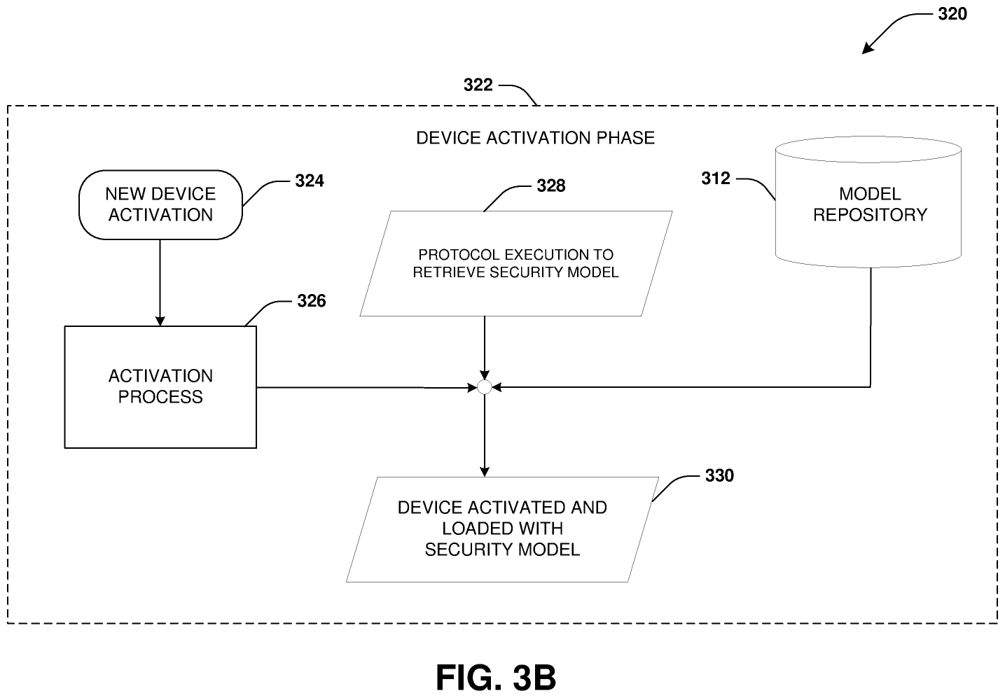

FIG. 2 is a flow chart illustrating an example method 200 for mobile device security profiling, which is illustrated in conjunction with system 300 of FIG. 3A, system 320 of FIG. 3B, and system 400 of FIG. 4. A training phase 302 may be performed for a new device such as by the security profile system 104, as illustrated by 3A. The training phase 302 is performed in order to generate device behavior security models for the new device. In some embodiments, the training phase 302 is performed as part of a new device network certification 304 that is used to certify the new device for utilizing the communication network 102. The new device network certification 304 may perform certification testing 306 that may test the new device's ability to connect to the communication network 102 (e.g., attach, register, and activate with the service provider system 103), communicate over the communication network 102, and/or verify any other functionality of the new device related to utilize the communication network 102. In some embodiments, the entire communication network 102 is simulated as part of the certification testing 306, such as where operations of base stations, cell towers, repeaters, user equipment, and/or other network elements are simulated to ensure that the new device will be able to operate correctly and within certain specifications while connected to the communication network 102.

As part of the certification testing 306, simulations of typical network traffic and simulations of network attacks as added 308 as part of the certification testing 306 (e.g., typical network traffic by or towards the new device, network attacks by or towards the new device, etc.). In some embodiments, each simulation may take into account different device types, different or default applications that could be hosted by the new device, different user behavior, different location/roaming behavior, and/or other software running on the new device such as different firmware or an operating system version. In some embodiments, the simulations are executed to generate normal behavior logs and abnormal behavior logs used for creating/training device behavior security models for different applications and use cases for detecting normal and abnormal device behavior. That is, machine learning is applied 310 to the output of the simulations such as to the normal behavior logs and abnormal behavior logs to generate device behavior security models for detecting normal and abnormal device behavior. The machine learning may identify what information (e.g., an application, a firmware version, an operating system version, messages exchanged between the new device and the communication network 102, data streams, device activity, or other device operating activity and/or device profile information) is relevant to determining whether the new device is behaving normally or abnormally. The machine learning model may determine how relevant each piece of information is to determining whether the new device is behaving normally or abnormally, and assigns weights to each piece of information (e.g., data streams of an application may be a greater indicator of abnormal behavior than a firmware version of the new device, and thus the data streams of the application may be assigned a higher weight than the firmware version).

In some embodiments, machine learning is applied to the output of the simulations to train a device behavior security model to detect abnormal behavior corresponding to security attacks by or towards the new device, abnormal signals generated by the new device, abnormal messages exchanged by the new device with the communication network 102, a DoS attack, etc. In some embodiments, machine learning is applied to the output of the simulations to train a device behavior security model to detect normal behavior such as normal messages exchanged by the new device with the communication network 102, normal signals, and/or other normal operation of the new device that does not provide a security or performance degradation risk for the communication network 102.

In some embodiments, the device behavior security model is generated to characterize certain input device operation activity (e.g., activity related to application execution, data streams, signals, messages exchanged with the communication network 102, etc.) as corresponding to normal device behavior. In some embodiments, the device behavior security model is generated to characterize certain input device operation activity as abnormal device behavior. The new device will be able to utilize the device behavior security model to become self-aware of normal and abnormal device behavior. In this way, the training phase 302 for the new device generates/trains device behavior security models that are stored within a model repository 312 so that the device behavior security models can be provided to new devices during activation or ongoing operation while connected to the communication network 102.

A device activation phase 322 may be performed as part of activating 324 a device on the communication network 102, as illustrated by FIG. 3B. An activation process 326 may be executed in response to receiving an activation request from the device to activate with the communication network 102 (e.g., activation 112 of device 106 by the service provider system 103), during operation 202 of method 200. For example, a user may purchase a new device (e.g., a smart watch, a phone, a tablet, etc.) and establish a service plan with a service provider of the service provider system 103 and/or communication network 102. A protocol (e.g. Subscriber Identity Module Over-the-Air—SIM-OTA or other Device Management—OMA DM) may be executed 328 to cause the device to retrieve a device behavior security model from the model repository 312 such as through the security profile system 104 and/or the service provider system 103. As part of executing 328 the protocol, device profile information associated with the device may be identified, during operation 204 of method 200. The device profile information may include a device type (e.g., a particular model of a smart phone), an operating system version, a firmware version, location information (e.g., the device may be located within a particular geographical region), and/or installed applications that are installed on the device. In some embodiments, device profile information may be received by the service provider system 103 from the device 106 as part of the activation process 326.

During operation 206 of method 200, a device behavior security model may be selected from available device behavior security models within the model repository 312 based upon the device profile information corresponding to the device behavior security model. In some embodiments, each device behavior security model is represented as a vector of attributes (e.g., a device type attribute, an operating system attribute, a firmware version attribute, an installed application attribute, a location attribute, a user behavior attribute, etc.). Similarly, a device vector may be created based upon the device profile information. A vector comparison is performed between the device vector and the vectors representing the device behavior security models in order to identify one or more closest matching (best fit) device behavior security models that would have the highest likelihood of accurately indicating whether operation of the device is behaving normally or abnormally (e.g., multiple device behavior security models may be selected if a single device behavior security model cannot represent all capabilities of a device).

During operation 208 of method 200, the selected device behavior security model is transmitted from the service provider system 103 to the device (e.g., provided to the device while active on the communication network or as part of activation 112). In this way, the device is activated and loaded 330 with the device behavior security model. Once loaded 330 with the device behavior security model, the device will compare 404 device operating activity to the device behavior security model to determine 406 whether the device operating activity is within normal operating behavior threshold of the device behavior security model, as illustrated by the ongoing profiling phase 402 of FIG. 4. In some embodiments, system logs of the device are periodically compared with the device behavior security model to determine a likelihood that the device is exhibiting abnormal behavior. The abnormal behavior may correspond to security attacks by or towards the device, abnormal signals generated by the device, abnormal messages exchanged by the device with the communication network 102, a DoS attack, etc.

If the device operating activity is within normal operating behavior threshold of the device behavior security model, the device determines that it is operating normally without any abnormal behavior and continues operation, which may be logged by the device. If the device behavior security model (e.g., an AI/ML based model, heuristics, a definite or probable model, etc.) indicates that the device is operating abnormally (e.g., the device operating activity is not within a normal operating behavior threshold; the device behavior security model outputs a binary decisions that the device is operating abnormally or normally; etc.), then a remedial action 408 is performed, which may be logged by the device. The remedial action may include blacklisting an application hosted by the device, blocking execution of the application, disconnecting the device from the communication network 102, restarting/resetting the device, displaying an alert, generating an alert or report that is emailed or messaged to a user of the device or to the service provider, disconnecting and clearing a session, etc.

The device may monitor for a trigger event 410. The trigger event 410 may correspond to the installation of a new application, the device changing locations (e.g., the device moving at least 50 miles or some other geographical relocation), the device updating firmware, the device updating an operating system, a certain amount of time lapsing since the device last checked to determine if the model repository 312 stored a more accurate/relevant device behavior security model that would provide more accurate indications of abnormal and normal device behavior, detecting of new user behavior (e.g., the user recently interacting with certain applications, the user recently sending certain messages, etc.), or any other change that could result in different/changed device profile information for the device. In response detecting the trigger event 410, updated device profile information is sent from the device to the security profile system 104 such as through the service provider system 103. The security profile system 104 may utilize the updated device profile information to select a device behavior security from available device behavior security models within the model repository 312 based upon the selected device behavior security model closest matching the updated device profile information. If the selected device behavior security model is the same as the existing device behavior security model loaded by the device, then a notification is provided to the device to continue using the existing device behavior security model. If the device behavior security model is different than the device behavior security model loaded by the device, then an action is performed such as where the device behavior security model is provided 412 to the device to use in place of the existing device behavior security model, the device is instructed to continue using the existing device behavior security model, or the existing device behavior security model and the device behavior security model are combined such as added or concatenated together.

In some embodiments, the security profile system 104 may receive operational information from devices. The security profile system 104 may utilize the operational information for model tuning of existing device behavior security models and/or for the creation of new device behavior security models. The operational information may include logs of device activity and/or updated device profile information such as a device type, an operating system version, a firmware version, location information, installed applications, device activity, data streams, network messages, and/or classifications by the device using an existing device behavior security model as to whether certain information led to a determination that the device was operating normally or abnormally. The operational information from various devices may be clustered using clustering techniques (e.g., clusters of information relating to normal behavior and clusters of information relating to abnormal behavior), and the clusters are used to update or create new device behavior security models.

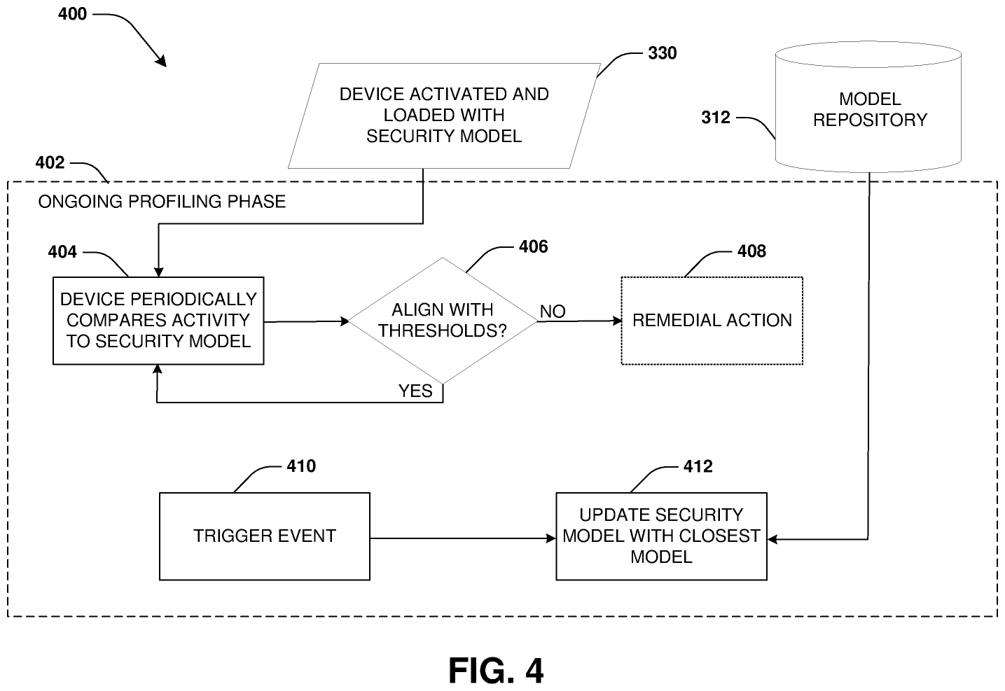

FIG. 5 is a flow chart 500 illustrating an example method for mobile device security profiling. A communication network may include the service provider system 103, the security profile system 104, and/or device activation elements 508 used for device activation of a device 502. In some embodiments, the device 502 transmits an activation request with device profile information to the service provider system 103, or the device 502 may not be initiating a connection, but may already be connected to the communication network and is in a listening mode for receiving device behavior security models (e.g., the device 502 does not transmit the activation request, but is capable of receiving device behavior security models or other instructions). If the device is initiated the connection, then service provider system 103 transmits the activation request with device profile information to the device activation elements 508. The device activation elements 508 retrieve a device behavior security model (baseline profile) from the security profile system 104. The device behavior security model is selected using the device profile information. The device activation elements 508 perform an activation through the service provider system 103 with the device 502. The activation includes loading the device 502 with the device behavior security model. In this way, the device 502 utilizes the device behavior security model to detect normal and abnormal operating behaviors.

A trigger event 504 such as the installation of a new application on the device 502 may be detected. Accordingly, the device 502 performs a device profile update by sending a request to the service provider system 103 for a latest device behavior security model (e.g., the device profile update may include receiving a device behavior security model that is appended to an existing device behavior security model used by the device 502). The service provider system 103 queries the security profile system 104 with current device profile information of the device 502 in order to identify a device behavior security model that best matches the current device profile information. In this way, the device 502 may be reconfigured with the device behavior security model if the existing model is not the best fit for the given device 502.

In some embodiments, the device 502 may trigger 506 a periodic update where the device 502 transmits updated operational information through the service provider system 103 to the security profile system 104 to use for model tuning of existing device behavior security models and/or creation of new device behavior security models. The operational information may include logs of device activity and/or updated device profile information such as a device type, an operating system version, a firmware version, location information, installed applications, device activity, data streams, network messages, and/or classifications by the device using an existing device behavior security model as to whether certain information lead to a determination that the device was operating normally or abnormally. The operational information is used to update or create new device behavior security models. In some embodiment, an existing device behavior security model is updated by changing weights related to how important certain information (e.g., OS firmware version, a particular application, etc.) is when detecting abnormal device behavior (e.g., operation of a particular application may be a stronger indicator of normal/abnormal device behavior than a particular firmware version, and thus the application may be weighted more than the firmware version in the updated device behavior security model).

In some embodiments, the device 502 locally stores the device behavior security model. The device 502 locally utilizes the device behavior security model to determine whether the device 502 is behaving normally or abnormally. In some embodiments, the device behavior security model is stored remote to the device 502 such as within a centralized system of the communication network or any other computing device or network equipment. The device 502 may send activity streams of operating activity of the device 502 to the centralized system. The centralized system evaluates the operating activity of the device 502 using the device behavior security model mapped to the device 502 in order to determine whether the device is behaving normally or abnormally. If the centralized system determines that the device 502 is behaving abnormally, then the centralized system may implement a remedial action or may instruct the device 502 to implement the remedial action.

According to some embodiments, a method is provided. The method includes detecting a device connected to a communication network; identifying device profile information associated with the device; selecting a device behavior security model from available device behavior security models based upon the device profile information corresponding to the device behavior security model; and transmitting the device behavior security model to the device, wherein the device compares device operating activity to the device behavior security model to determine whether the device operating activity is within normal operating behavior thresholds of the device behavior security model; and executing a remedial action based upon the device operating activity not being within the normal operating behavior thresholds.

According to some embodiments, the method includes receiving updated device profile information from the device in response to a trigger event occurring; selecting a different device behavior security model from currently available device behavior security models based upon the updated device profile information corresponding to the different device behavior security model; and transmitting the different device behavior security model to the device for replacing the device behavior security model.

According to some embodiments, the method includes monitoring for the trigger event as at least one of installation of a new application on the device, a firmware update, an operating system update, a location change, or an identified new user behavior.

According to some embodiments, the method includes generating the device behavior security model to characterize input device operating activity as corresponding to normal device behavior and abnormal device behavior, wherein the device utilizes the device behavior security model to become self-aware of normal and abnormal device behavior.

According to some embodiments, the method includes simulating operation of devices within the communication network to generate simulation results, wherein the simulating includes normal behavior simulations and abnormal behavior simulations; and applying machine learning to the simulation results to generate the available device behavior security models.

According to some embodiments, the method includes receiving updated device profile information from the device, wherein the updated device profile information includes at least one of a device type, an operating system version, a firmware version, location information, installed applications, device activity, data streams, network messages, or classifications of normal or abnormal behavior detected by the device using the device behavior security model; and generating a new device behavior security model based upon the updated device profile information.

According to some embodiments, the method includes executing the remedial action to at least one of blacklisting an application, block execution of the application, disconnect from the communication network, restart the device, or generate an alert.

According to some embodiments, the method includes training the device behavior security model to detect abnormal behavior corresponding to a security attack by devices, abnormal signals generated by the devices, abnormal messages exchanged by the devices with the communication network, or a denial of service attack.

According to some embodiments, the device profile information includes at least one of a device type, an operating system version, a firmware version, location information, or installed applications.

According to some embodiments, the method includes representing the available device behavior security models as vectors; generating a device vector using the device profile information; and comparing the device vector to the vectors to identify the device behavior security model.

According to some embodiments, a system comprising one or more processors configured for executing the instructions to perform operations, is provided. The operations include detecting a device connected to a communication network; identifying device profile information associated with the device; selecting a device behavior security model from available device behavior security models based upon the device profile information corresponding to the device behavior security model; and transmitting the device behavior security model to the device, wherein the device compares device operating activity to the device behavior security model to determine whether the device operating activity is within normal operating behavior thresholds of the device behavior security model; and executing a remedial action based upon the device operating activity not being within the normal operating behavior thresholds.

According to some embodiments, the operations include executing simulations of the device to generate normal behavior logs and abnormal behavior logs for training the available device behavior security models for different applications and use cases.

According to some embodiments, the operations include executing the simulations to take into account a device type, a device profile, and software running on the device.

According to some embodiments, the operations include comparing, by the device, system logs with the device behavior security model to determine a likelihood of abnormal behavior being exhibited by the device.

According to some embodiments, the operations include in response to receiving operational information from devices, performing model tuning for the available device behavior security models.

According to some embodiments, the operations include generating a new device behavior security model based upon logs of device activity and clustering techniques.

According to some embodiments, a non-transitory computer-readable medium storing instructions that when executed facilitate performance of operations, is provided. The operations include detecting a device connected to a communication network; identifying device profile information associated with the device; selecting a device behavior security model from available device behavior security models based upon the device profile information corresponding to the device behavior security model; and transmitting the device behavior security model to the device, wherein the device compares device operating activity to the device behavior security model to determine whether the device operating activity is within normal operating behavior thresholds of the device behavior security model; and executing a remedial action based upon the device operating activity not being within the normal operating behavior thresholds.

According to some embodiments, the operations include executing simulations of the device to generate normal behavior logs and abnormal behavior logs for training the available device behavior security models for different applications and use cases.

According to some embodiments, the operations include comparing, by the device, system logs with the device behavior security model to determine a likelihood of abnormal behavior being exhibited by the device.

According to some embodiments, the operations include in response to receiving operational information from devices, performing model tuning for the available device behavior security models.

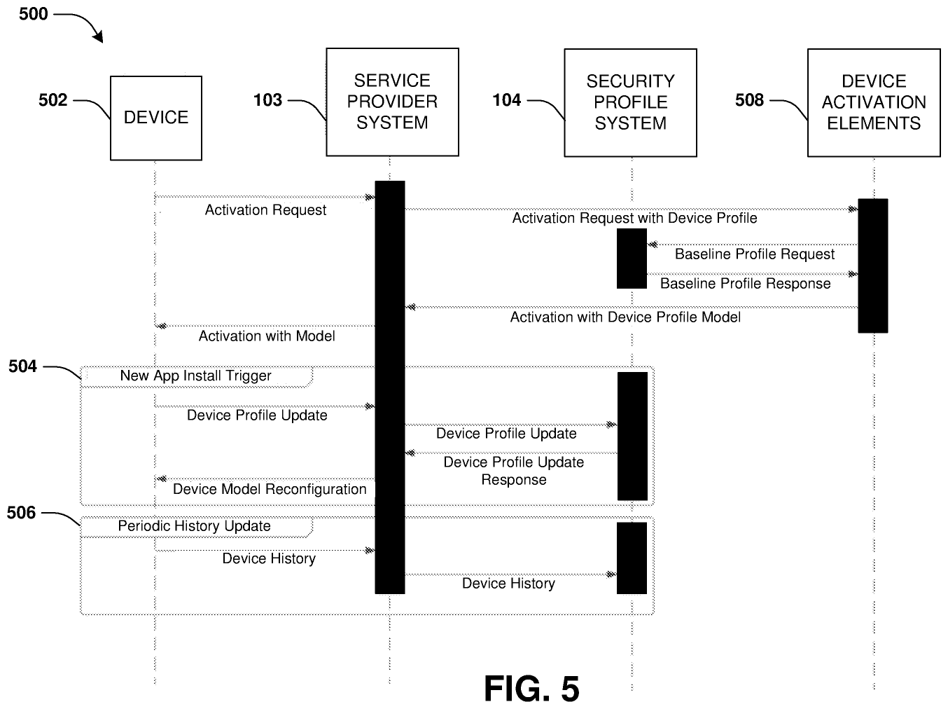

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1, at least some of example system 300 of FIG. 3A, at least some of example system 320 of FIG. 3B, and/or at least some of example system 400 of FIG. 4.

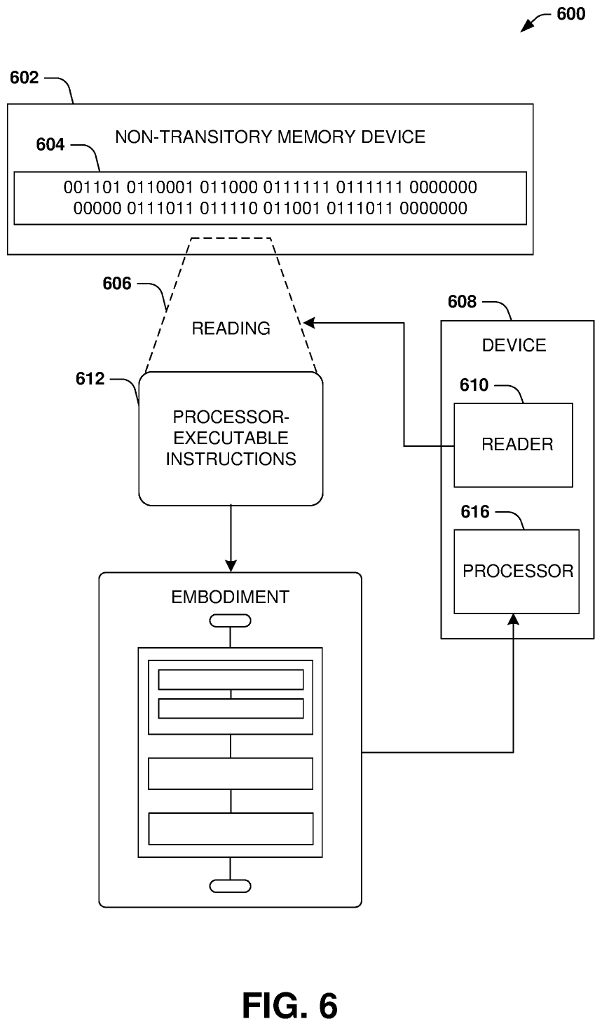

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

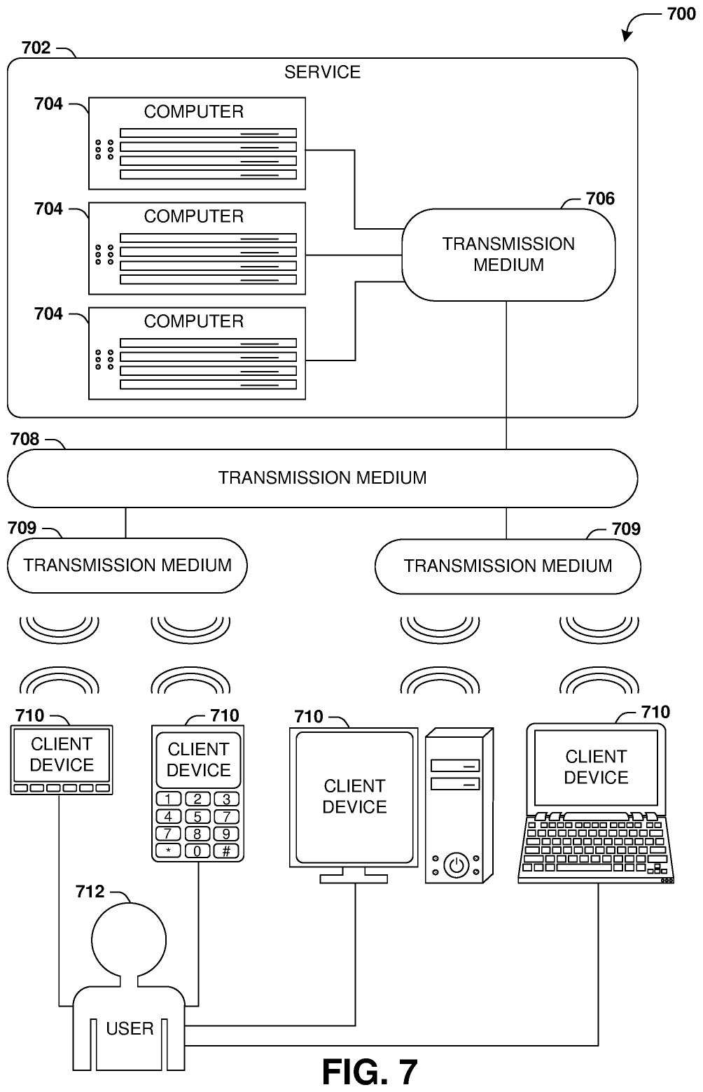

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

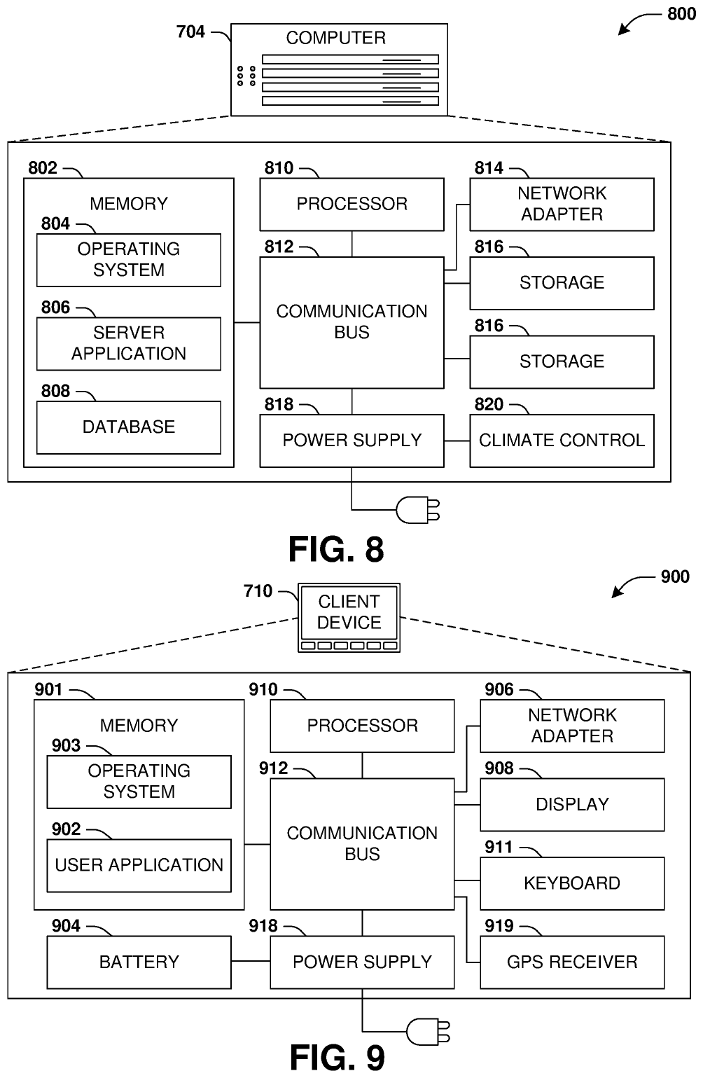

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
detecting a device connected to a communication network;
identifying device profile information associated with the device;
selecting a device behavior security model from available device behavior security models based upon the device profile information corresponding to the device behavior security model;
transmitting the device behavior security model to the device, wherein the device compares device operating activity to the device behavior security model to determine whether the device operating activity is within normal operating behavior thresholds of the device behavior security model; and
executing a remedial action based upon the device operating activity not being within the normal operating behavior thresholds.

2. The method of claim 1, comprising:
receiving updated device profile information from the device in response to a trigger event occurring;
selecting a different device behavior security model from currently available device behavior security models based upon the updated device profile information corresponding to the different device behavior security model; and
transmitting the different device behavior security model to the device for replacing the device behavior security model.

3. The method of claim 2, comprising:
monitoring for the trigger event as at least one of installation of a new application on the device, a firmware update, an operating system update, a location change, or an identified new user behavior.

4. The method of claim 1, comprising:
generating the device behavior security model to characterize input device operating activity as corresponding to normal device behavior and abnormal device behavior, wherein the device utilizes the device behavior security model to become self-aware of normal and abnormal device behavior.

5. The method of claim 1, comprising:
simulating operation of devices within the communication network to generate simulation results, wherein the simulating includes normal behavior simulations and abnormal behavior simulations; and
applying machine learning to the simulation results to generate the available device behavior security models.

6. The method of claim 1, comprising:
receiving updated device profile information from the device, wherein the updated device profile information includes at least one of a device type, an operating system version, a firmware version, location information, installed applications, device activity, data streams, network messages, or classifications of normal or abnormal behavior detected by the device using the device behavior security model; and
generating a new device behavior security model based upon the updated device profile information.

7. The method of claim 1, comprising:
executing the remedial action to at least one of blacklisting an application, block execution of the application, disconnect from the communication network, restart the device, or generate an alert.

8. The method of claim 1, comprising:
training the device behavior security model to detect abnormal behavior corresponding to a security attack by devices, abnormal signals generated by the devices, abnormal messages exchanged by the devices with the communication network, or a denial of service attack.

9. The method of claim 1, wherein the device profile information includes at least one of a device type, an operating system version, a firmware version, location information, or installed applications.

10. The method of claim 1, comprising:
representing the available device behavior security models as vectors;
generating a device vector using the device profile information; and
comparing the device vector to the vectors to identify the device behavior security model.

11. A system, comprising:
one or more processors configured for executing instructions to perform operations comprising:
detecting a device connected a communication network;
identifying device profile information associated with the device;
selecting a device behavior security model from available device behavior security models based upon the device profile information corresponding to the device behavior security model;
transmitting the device behavior security model to the device, wherein the device compares device operating activity to the device behavior security model to determine whether the device operating activity is within normal operating behavior thresholds of the device behavior security model; and
executing a remedial action based upon the device operating activity not being within the normal operating behavior thresholds.

12. The system of claim 11, wherein the operations further comprise:
executing simulations of the device to generate normal behavior logs and abnormal behavior logs for training the available device behavior security models for different applications and use cases.

13. The system of claim 12, wherein the operations further comprise:
executing the simulations to take into account a device type, a device profile, and software running on the device.

14. The system of claim 11, wherein the operations further comprise:
comparing, by the device, system logs with the device behavior security model to determine a likelihood of abnormal behavior being exhibited by the device.

15. The system of claim 11, wherein the operations further comprise:
in response to receiving operational information from devices, performing model tuning for the available device behavior security models.

16. The system of claim 11, wherein the operations further comprise:
generating a new device behavior security model based upon logs of device activity and clustering techniques.

17. A non-transitory computer-readable medium storing instructions that when executed facilitate performance of operations comprising:
detecting a device connected to a communication network;
identifying device profile information associated with the device;
selecting a device behavior security model from available device behavior security models based upon the device profile information corresponding to the device behavior security model;
transmitting the device behavior security model to the device, wherein the device compares device operating activity to the device behavior security model to determine whether the device operating activity is within normal operating behavior thresholds of the device behavior security model; and
executing a remedial action based upon the device operating activity not being within the normal operating behavior thresholds.

18. The non-transitory computer-readable medium of claim 17, wherein the operations further comprise:
executing simulations of the device to generate normal behavior logs and abnormal behavior logs for training the available device behavior security models for different applications and use cases.

19. The non-transitory computer-readable medium of claim 17, wherein the operations further comprise:
comparing, by the device, system logs with the device behavior security model to determine a likelihood of abnormal behavior being exhibited by the device.

20. The non-transitory computer-readable medium of claim 17, wherein the operations further comprise:
in response to receiving operational information from devices, performing model tuning for the available device behavior security models.
